(19) United States
(12) Patent Application Publication
(10) Pub. No.: US 2003/0222874 A1
(43) Pub. Date: Dec. 4, 2003

(54) Animated character messaging system

(76) Inventors: Tae Kook Kong, Seoul (KR); Jong Gie Kim, Seoul (KR)

Correspondence Address: Michael A. Cantor, 35 Griffin South Road, Bloomfield, CT, 06002, US

(21) Appl. No.: 10/157,506

(22) Filed: May 29, 2002

(51) Int. Cl. G06T 15/70

(52) U.S. Cl. 345/473

(57) ABSTRACT

Disclosed is an animated character messaging system capable of transmitting effectively message, which a user wants to transmit to the other party, by communicating message containing letters and sound mutually with animated characters. The animated character messaging system includes an editing system for editing a message to be transmitted to the other party, generating an animated character by adding an animation effect to a specific character and generating an animated character message by combining the message to be transmitted with the animated character, a message storing part for storing an animated character massage to be transmitted and a received animated character massage, a communication interface allowing the terminals to communicate with each other through the Internet network, and a messenger system for selecting the animated character message generated by the editing system to then be stored in the message storing part, transmitting the selected animated character message through the communication interface, receiving the animated character message through the communication interface to the be stored in the message storing part and reproducing the message and the animated character from the received animated character message. According to the present invention, the user can transmit the desired message to the other party effectively by transmitting and receiving messages with animated characters mutually, make more interesting online games or more interesting online communities, and apply it to a presentation or an online education.

### BACKGROUND OF THE INVENTION

1. Field of the Invention

The present invention relates to an animated character messaging system, and more particularly, to an animated character messaging system capable of transmitting effectively message, which a user wants to transmit to the other party, by communicating message containing letters and sound mutually with animated characters.

2. Background of the Related Art

In general, chatting and information exchange using communication or an Internet are carried out on a communication emulator or a web browser. The chatting and information exchange based on the communication emulator or the web browser are, initially, carried out in such a manner that a virtual space, i.e., a chatting room, is made and lots of persons enter the room to communicate with others or exchange information. However, recently, developed is a technique for e-mail and chatting, which allows the users to chat with each other or among them in the form of a POP-mail that is put on a client PC. Furthermore, a messenger program, which supports real-time communication and chatting between two or more persons based on the technique, has been developed.

The messenger program demands the user, who wants to use it, to register as a member and to download a connection program to the user's computer. After that, the messenger program checks member information whenever the user connects to a messenger server, and shows several menus, such as an instant message menu, a friends menu, a chatting menu, an announcement menu, a help menu, and so on. If the user selects one of the menus, a program of the selected menu is operated.

However, because such messenger program is used for the purpose of transmission and reception of letters, infants and children who cannot read and write the letters well are restricted in using the messenger program. Therefore, a new messenger program having a new function that anybody can use it easily and with interests is needed. Especially, it is necessary to develop a new messenger program that the infants and children, who will be the leaders in future Internet world, can use it with interest in using the Internet.

### SUMMARY OF THE INVENTION

Accordingly, the present invention is directed to an animated character messaging system that substantially obviates one or more problems due to limitations and disadvantages of the related art.

An object of the present invention is to provide an animated character messaging system capable of transmitting effectively message, which a user wants to transmit to the other party, by communicating message containing letters and sound mutually with animated characters.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an animated character messaging system includes an editing system for editing a message to be transmitted to the other party, generating an animated character by adding an animation effect to a specific character and generating an animated character message by combining the message to be transmitted with the animated character; a message storing part for storing an animated character massage to be transmitted and a received animated character massage; a communication interface allowing the terminals to communicate with each other through the Internet network; and a messenger system for selecting the animated character message generated by the editing system to then be stored in the message storing part, transmitting the selected animated character message through the communication interface, receiving the animated character message through the communication interface to the be stored in the message storing part and reproducing the message and the animated character from the received animated character message.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1a illustrates a block diagram of a general configuration of an animated character messaging system according to the present invention;

FIG. 1b illustrates a block diagram of a detailed configuration of a messenger system in FIG. 1b;

FIG. 1c illustrates a block diagram of a detailed configuration of an editing system in FIG. 1a;

FIG. 2a illustrates a schematic diagram showing a message transmission process in the animated character messaging system according to the present invention;

FIG. 2b illustrates a flow chart showing a basic message selection process;

FIG. 2c illustrates a character message preview process;

FIG. 3a illustrates a flow chart showing a process for transmitting a character message to a server in the animated character messaging system according to the present invention;

FIG. 3b illustrates a flow chart showing a process for transmitting the character message to the other party in a P2P mode;

FIG. 3c illustrates a flow chart showing a process for transmitting the character message to the other party in the form of e-mail;

FIG. 4 illustrates a view showing a state that the message is displayed on a terminal when being received to the terminal;

FIG. 5a illustrates a flow chart showing a process that the character message is received from the server in the animated character messaging system according to the present invention;

FIG. 5b illustrates a flow chart showing a process that the character message is received from the other party in the P2P mode; and

FIG. 5c illustrates a flow chart showing a process that the character message is received from the other party in the form of e-mail.

### DETAILED DESCRIPTION OF THE PREFERRED EMBODIMENT

Reference will now be made in detail to the preferred embodiments of the present invention, examples of which are illustrated in the accompanying drawings.

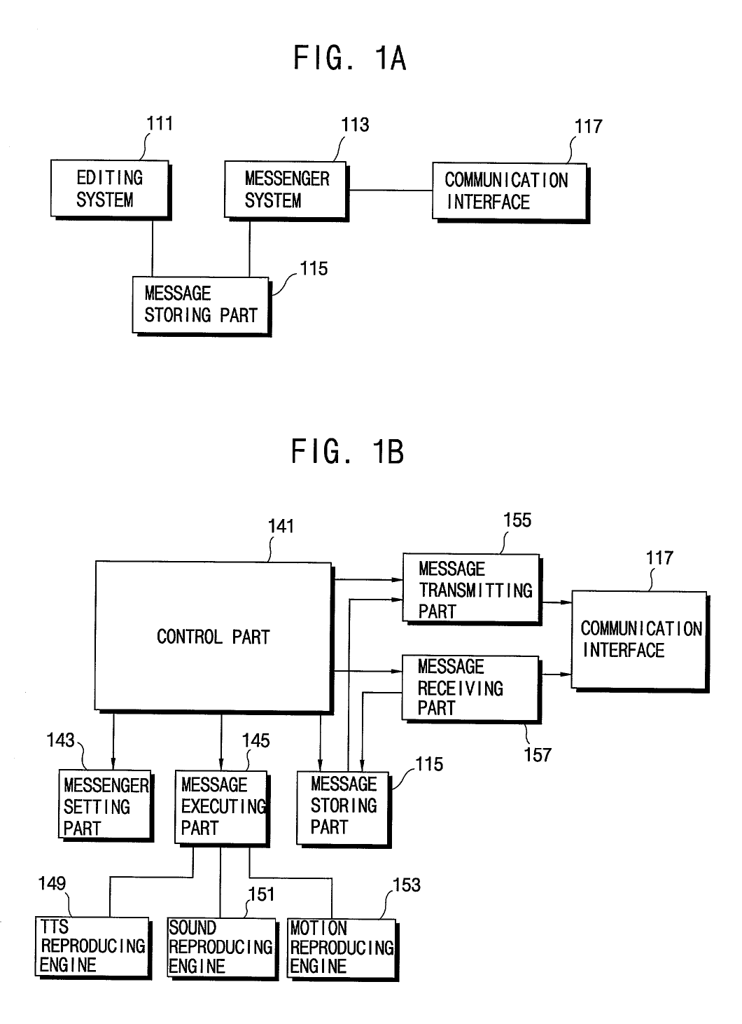

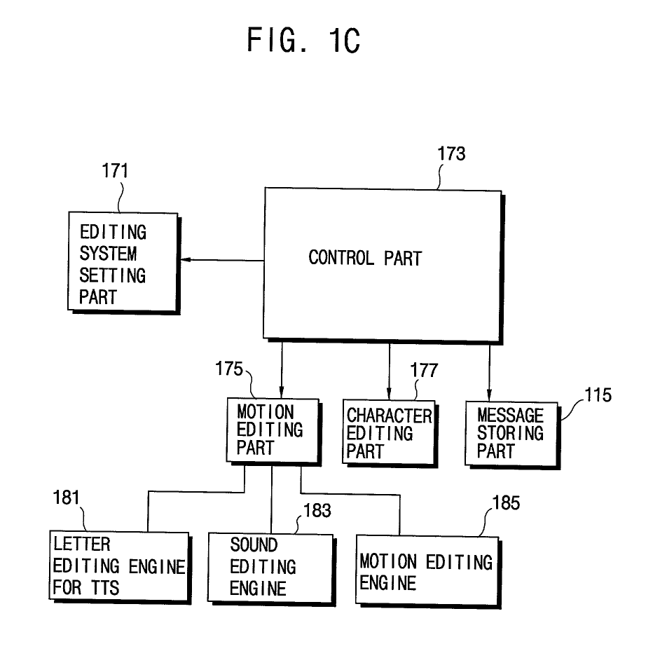

FIG. 1a illustrates a block diagram of a general configuration of an animated character messaging system according to the present invention. The animated character messaging system includes an editing system 111 for generating an animated character message by editing a massage to be transmitted and animated characters, respectively to then be combined with each other, a messenger system 113 for transmitting and receiving the animated character messages mutually and reproducing the received animated character massage, a message storing part 115 for storing an animated character massage to be transmitted and a received animated character massage, and a communication interface 117 allowing the messenger system 113 to transmit and receive the animated character messages through an Internet network.

The above-mentioned components 111, 113, 115 and 117 can be operated in terminals, such as computers, cellular phones, PDAs, electronic notes, etc., using the Internet network, and other terminals capable of transmitting and receiving the messages mutually using the Internet network. Meanwhile, of course, an e-mail program and a P2P program are installed in the terminals for transmitting and receiving the animated character messages in various ways.

An animated character together with a message which a user wants to transmit are included in the information to be transmitted to the other party, according to the present invention and hereinafter the information to be transmitted to the other party is called “an animated character message.” The animated character message is compressed to then be transmitted in a transmitting side and the transmitted animated character message is decompressed to then be reproduced in a receiving side, similar to the transmission and reception of information via a communication network.

The messenger system 113 of FIG. 1a is explained in more detail with reference to FIG. 1b. In the messenger system 113, a control part 141 controls transmission and reception of the animated character message, execution of the received animated character message and storing of the transmitted and the received messages by controlling the messenger system 113. A message transmission part 155 and message reception part 157 transmits and receives the animated character message respectively through the communication interface 117. The message transmission part 155 transmits the animated character message stored in the message storing part 115 and the message reception part 157 stored the received animated character message in the message storing part 115. The communication interface 117 uses communication protocols related with an Internet, such as TCP/IP, UDP, HTTP, FTP, etc., and other protocols capable of allowing transmission and reception of the message through the Internet network can be used. Meanwhile, the message transmission part 155 and the message reception part 157 are connected with the Internet network through the communication interface 117 using three methods: first, a method for transmitting and receiving the animated character message through a specified server, second, a method for transmitting and receiving the animated character message in the P2P mode, and third, a method for transmitting and receiving the animated character message using the e-mail.

Furthermore, the messenger system 113 further includes a messenger setting part 143 and a message executing part 145. The messenger setting part 143 is to set the operating environment of the messenger system 113, and has various functions, that is, a function for automatically actuating the messenger system 113 when a terminal is turned on, a function for interrupting transmission of messages from specific persons, a function for setting the operating environment of the TTS reproducing engine 149 and the sound reproducing engine 151 to execute when the animated character message is received, a function for reducing or amplifying sound of a sound message, a function for setting a mail server in case of the message received in the form of e-mail, a function for setting a period for checking e-mail from the mail server, and a TTS (Text-to-Speech) reproducing and setting function. Besides the above functions, the messenger setting part 143 can has other functions convenient in using the messenger system 113.

The message executing part 145 is to reproduce the received animated character message and preferably includes a TTS reproducing engine 149, a sound reproducing engine 151, and a message motion reproducing engine 153. The TTS reproducing engine 149 is to reproduce letters of the animated character message containing the letters in a TTS mode, the sound reproducing engine 151 is to reproduce sound of the animated character message containing sound, and the message motion reproducing engine 153 is to reproduce motion of an animated character.

Meanwhile, the editing system 111 of FIG. 1a is explained in more detail with reference to FIG. 1c. The editing system 111 includes a control part 171, an editing system setting part 173, a motion editing part 175 and a character editing part 177.

The control part 171 overall controls the editing system 111 and allows the character editing part 177 and the motion editing part 175 to perform the message editing, the character editing and the character motion editing etc. according to conditions set by the editing system setting part 173.

The editing system setting part 173 performs various functions for setting the operating environment of the editing system 111, that is, a function for automatically storing the character message periodically which is being edited, a function for copying/inserting an object, a drawing tool function related in making characters and so on.

The character editing part 177 has a function for selecting/editing characters to be transmitted.

The motion editing part 175 edits a message to be transmitted, generates an animated character by adding an animation effect to the character which the user selects/edits using the character editing part 177, and generates an animated character message by combining the message to be transmitted with the animated character. The motion editing part 175 includes a TTS letter editing engine 181, a sound editing engine 183 and a message motion editing engine 185. The TTS letter editing engine 181 has a function for inputting/editing a desired letter message and allowing the other party receiving the letter message to convert the received letter message in the TTS mode so as to hear the message in sound when the user inputs a desired letter message. The sound editing engine 183 has a function for directly recording/editing a desired sound message such as a user's voice or music and the message motion editing engine 185 has a function for generating an animated character by adding an animation effect to the character which the user selects/edits using the character editing part 177 and generating an animated character message by combing a letter or sound message with the animated character.

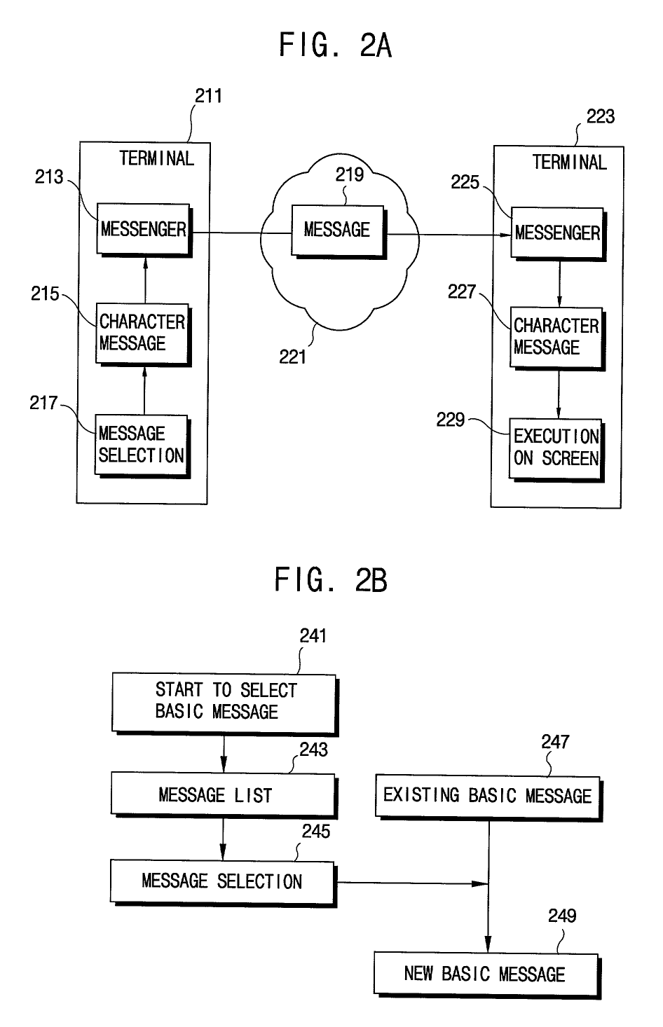

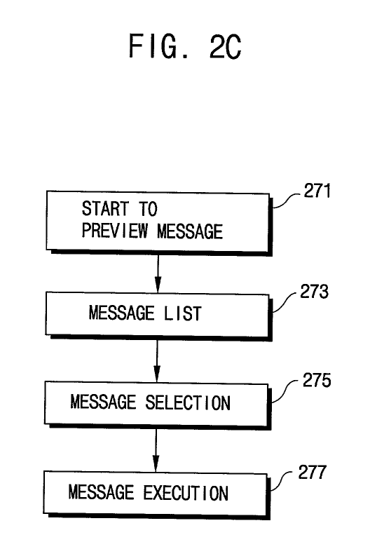

FIG. 2a illustrates a flow chart showing a message transmission process in the messenger system 113 of the animated character messaging system according to the present invention. An animated character message 219 is transmitted through a terminal 211 for message transmission, a terminal 223 for message reception, and an Internet network 221 connecting the terminal 211 for message transmission and the terminal 223 for message reception. The terminal 211 for message transmission selects a message and an animated character to be transmitted (steps 215 and 217) and transmits the animated character message 219 through the Internet network 221. The terminal 223 for message reception executes the animated character message 227, which the messenger system 113 receives, on a screen (step 229).

FIG. 2b illustrates a flow chart showing a basic animated character message selection process. In this case, a default animated character message set in the messenger system 113 is designated. When the user starts to select the basic message (step 241), the messenger system 113 displays a current animated character message list of the terminal (step 243), and when the user selects a desired message (step 245), the basic message set previously is changed into a new basic message (steps 247 and 249). The basic animated character message means a message that a user wants to use as a default message and the user may modify only the letter or sound message maintaining the basic animated character as it is, if necessary.

FIG. 2c illustrates an animated character message preview process. When the user selects a “preview” menu (step 271), the animated character message list is displayed (step 273), and at this time, when the user selects an animated character message that the user wants to see first (step 275), a scene that the selected animated character message is executed is shown (step 277).

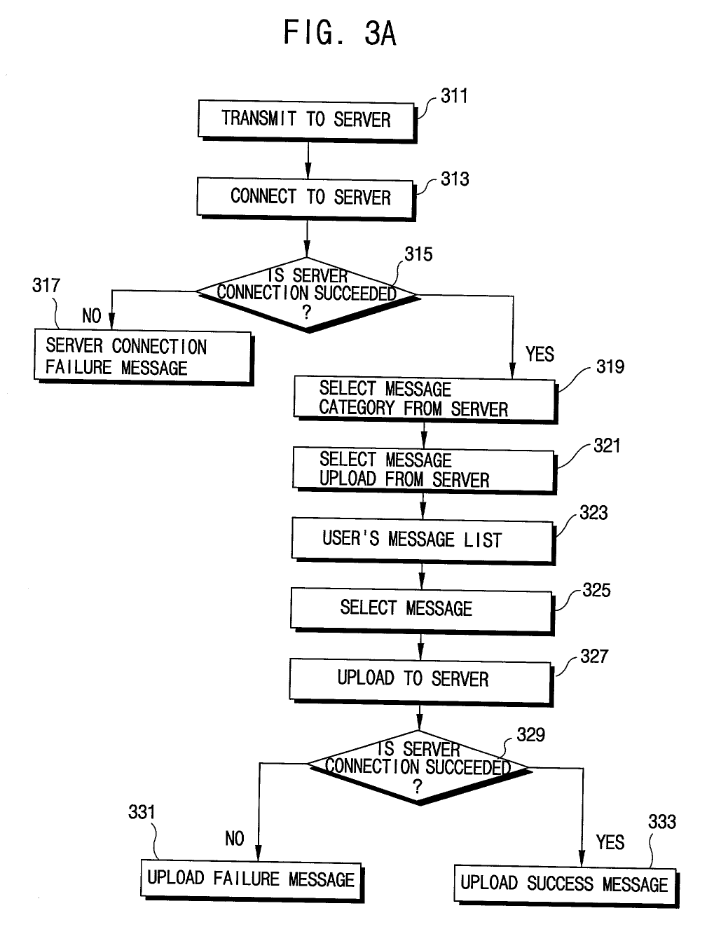

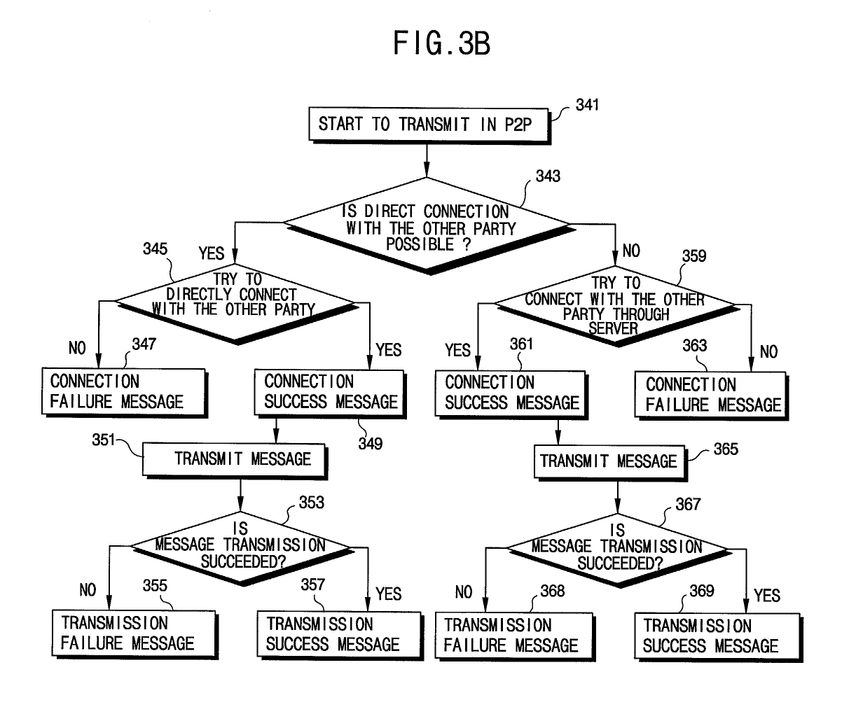

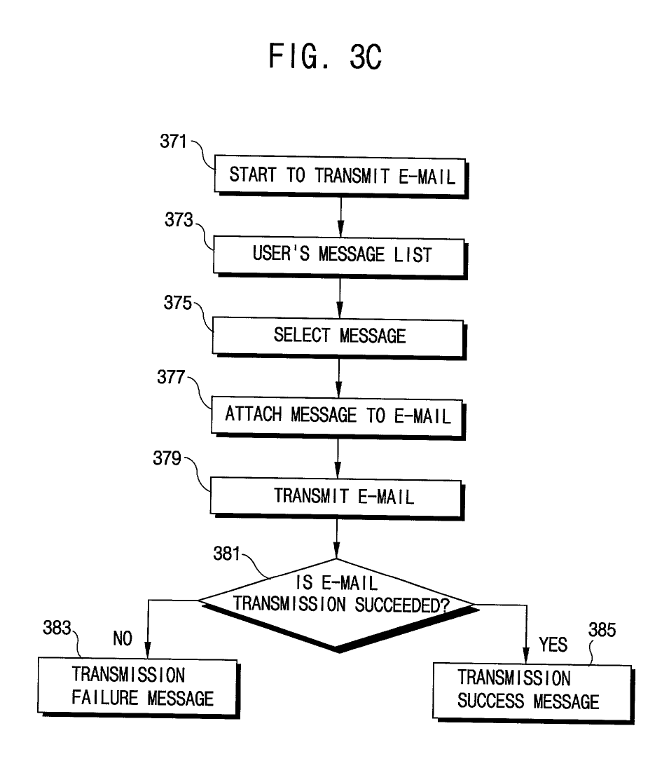

Meanwhile, in the animated character messaging system according to the present invention, to transmit the animated character message to the other party, there are three methods: first, a method for transmitting through the server, second, a method for transmitting in the P2P mode, and third, a method for transmitting using the e-mail. Referring to FIGS. 3a to 3c, the transmission methods will be described as follows.

FIG. 3a illustrates a flow chart showing a process for transmitting the animated character message to the server in the messenger system 113 of the animated character messaging system according to the present invention. When the user selects a “transmit to server” menu (step 311), the messenger system 113 tries to connect to the server (steps 313 and 315), and if the server connection is failed, a “server connection failure” message is displayed (step 317). Meanwhile, if the messenger system 113 is connected to the server, in the case that the user selects a message category and a message upload from the message list in turn (steps 319 and 321), the server displays the animated character message list of the user's terminal (step 323). When the user selects a message, which the user wants to download, in the animated character message list (step 325), the selected animated character message is uploaded (step 327) to the server. After whether or not the animated character message is uploaded is determined (step 329), an “upload failure” message is displayed (step 331) if the upload is failed, but an “upload success” message is displayed (step 333) if the upload is succeeded.

FIG. 3b illustrates a flow chart showing a process for transmitting the animated character message to the other party in the P2P mode. When the user selects a “transmit in P2P mode” menu (step 341), the user's messenger system 113 checks whether or not it can be directly connected to the other party's messenger system (step 343). If it is possible, the messenger system 113 tries to directly connect to the other party's terminal (step 345). If it is failed, the “connection failure” message is displayed (step 347), but if it is succeeded, the “connection success” message is displayed (step 349), and then the animated character message is transmitted (step 351). After the messenger system 113 determines whether or not the animated message is transmitted (step 353), if it is failed, a “transmission failure” message is displayed (step 355), but if it is succeeded, a “transmission success” message is displayed (step 357). Meanwhile, in the step 343, if the messenger system 113 cannot be connected directly, it tries to connect through the server (step 359). If it is failed, a “transmission failure” message is displayed (step 363), but if it is succeeded, a “transmission success” message is displayed (step 361), and then the animated character message is transmitted (step 365). After the messenger system 113 determines whether or not the animated character message is transmitted (step 367), if it is failed, a “transmission failure” message is displayed (step 368), but if it is succeeded, a “transmission success” message is displayed (step 369).

FIG. 3c illustrates a flow chart showing a process for transmitting the animated character message to the other party in the form of e-mail. When the user selects a “transmit e-mail” menu (step 371), the messenger system 113 displays the message list of the user's terminal (step 373). The user selects a desired message from the message list (step 375), attaches the selected message to e-mail (step 377), and then transmits the message in the form of e-mail (step 379). After the messenger system 113 determines whether or not the mail is transmitted (step 381), if it is failed, a “transmission failure” message is displayed (step 383), but if it is succeeded, a “transmission success” message is displayed (step 385).

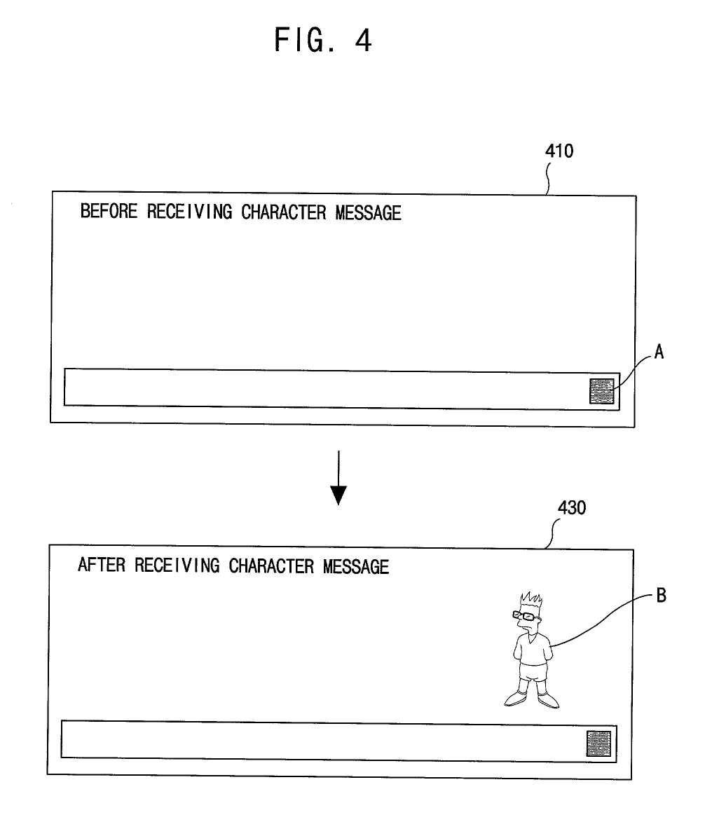

FIG. 4 illustrates a view showing a state that the animated character message is displayed on the terminal when being received to the terminal. The terminal displays a screen status (410) before receiving the animated character message and a screen status (430) after receiving the animated character message. When the animated character message is received, the received animated character message is automatically executed and displayed on the screen. In FIG. 4, ‘A’ is an icon of the messenger system 113 and ‘B’ is an operating status of the animated character message, which the messenger system 113 receives. At this time, while the received animated character message is executed, the character pronounces a letter message or outputs a sound message using a TTS technique.

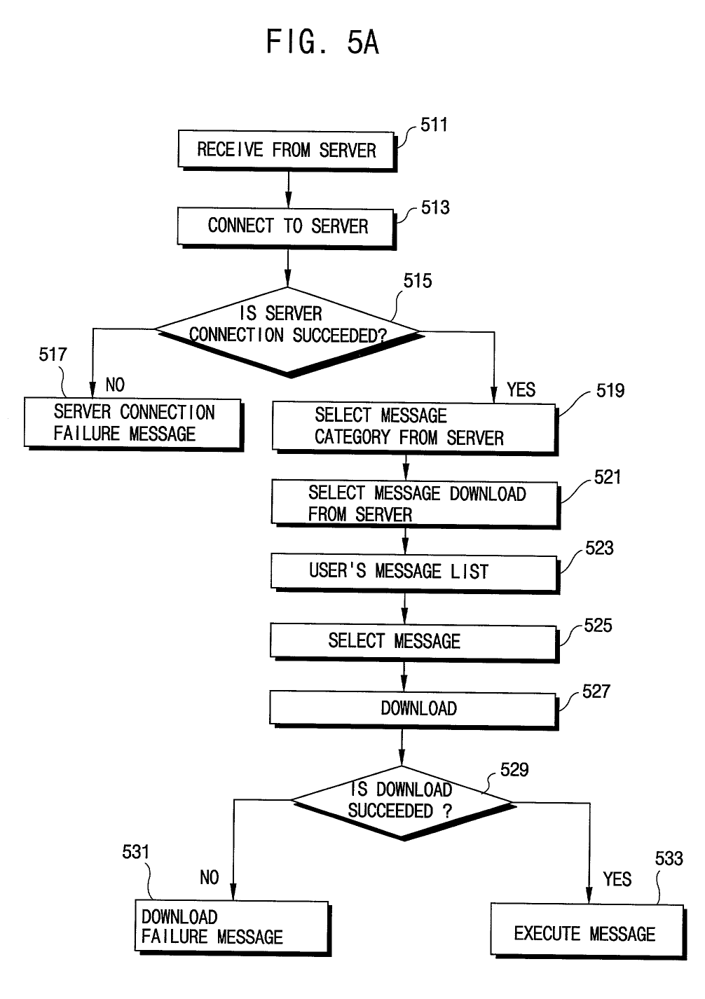

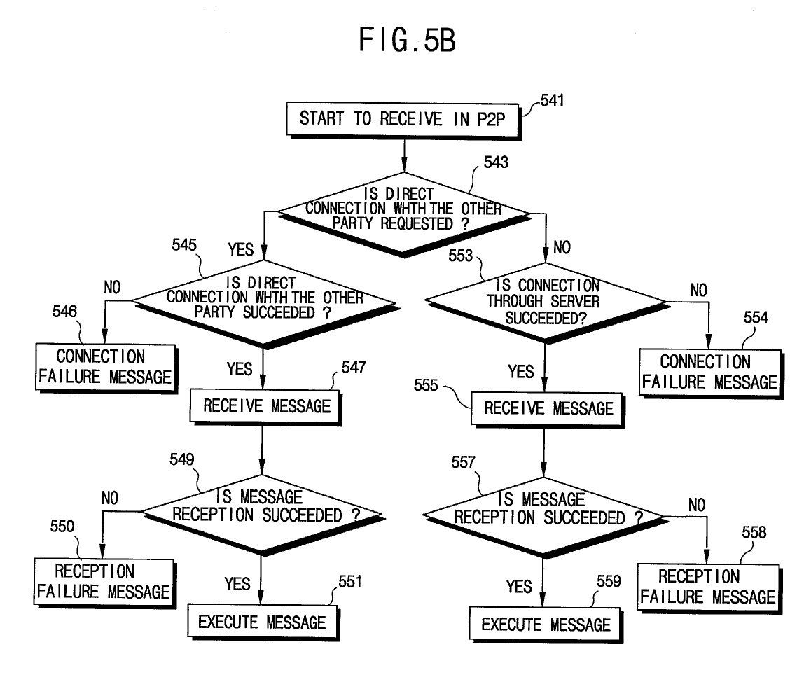

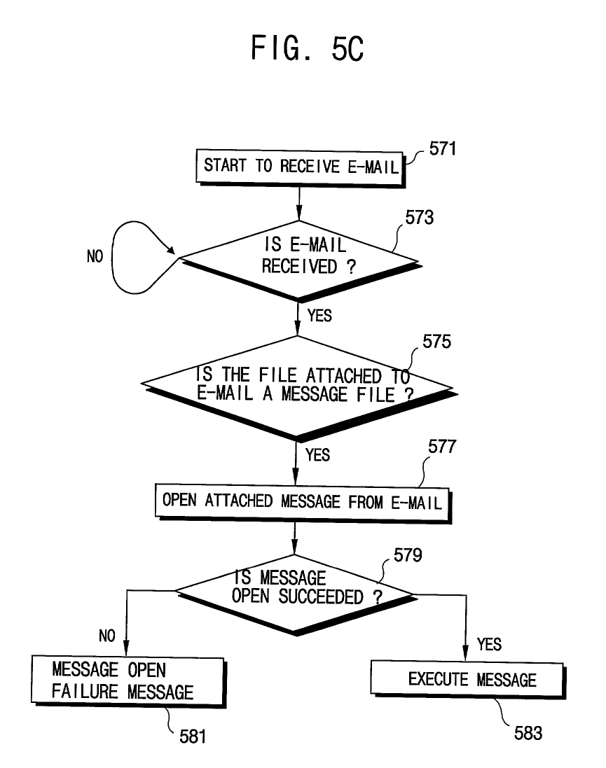

In the same way as the above, in the animated character messaging system according to the present invention, to receive the animated character message from the other party, there are three methods: first, a method for receiving through the server, second, a method for receiving in the P2P mode, and third, a method for receiving using the e-mail. Referring to FIGS. 5a to 5c, the reception methods will be described as follows.

FIG. 5a illustrates a flow chart showing a process that the animated character message is received from the server in the messenger system 113 of the animated character messaging system according to the present invention. When the user selects a “receive to server” menu (step 511), the messenger system 113 tries to connect to the server (steps 513 and 515), and if the server connection is failed, a “server connection failure” message is displayed (step 517). Meanwhile, if the messenger system 113 is connected to the server, in the case that user selects a message category and a message upload from the server in turn (steps 519 and 521), the server displays the received animated character message list (step 523). When the user selects a message, which the user wants to download, in the animated character message list (step 525), the selected animated character message is downloaded from the server (step 527). After whether or not the message is downloaded is determined (step 529), a “download failure” message is displayed (step 531) if the download is failed, but a “download success” message is displayed (step 533) if the download is succeeded.

FIG. 5b illustrates a flow chart showing a process that the animated character message is received from the other party in the P2P mode. When the user selects a “receive in P2P mode” menu (step 541), the messenger system 113 checks whether or not the other party's terminal requested the direct connection (step 543). If the other party's terminal requested the direct connection, the messenger system 113 tries to directly connect to the other party's terminal (step 545). If it is failed, the “connection failure” message is displayed (step 546), but if it is succeeded, the animated character message is received (step 547). After the messenger system 113 determines whether or not the animated character message is received (step 549), if it is failed, a “transmission failure” message is displayed (step 550), but if it is succeeded, the animated character message is executed (step 551). Meanwhile, in the step 543, if the messenger system 113 cannot be connected directly, it tries to connect through the server (step 553). If it is failed, a “transmission failure” message is displayed (step 554), but if it is succeeded, the animated character message is received (step 555). After the messenger system 113 determines whether or not the animated character message is transmitted (step 557), if it is failed, a “transmission failure” message is displayed (step 558), but if it is succeeded, the animated character message is executed (step 559).

FIG. 5c illustrates a flow chart showing a process that the animated character message is received from the other party in the form of e-mail. The user selects a “received e-mail” menu (step 571), and then the messenger system 113, automatically is connected to the mail server for checking whether or not the e-mail is received (step 573). If the mail is received, the user checks whether or not an attached file of the mail is an animated character message file (step 575), and executes an “open attached message” in the mail if it is the animated character message file (step 577). The messenger system 113 determines whether or not the “open attached message” is succeeded (step 579), if it is failed, a “file opening failure” message is displayed (step 581), and if it is succeeded, the message is executed (step 583).

As described above, according to the animated character messaging system of the present invention, the user can transmit the desired message to the other party effectively by transmitting and receiving messages with animated characters mutually, make more interesting online games or more interesting online communities, and apply it to a presentation or an online education. Additionally, the animated character message can be an online content, and the contents of the animated character messages can be sold on online using the Internet server, thereby making profit.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An animated character messaging system installed at terminals capable of using an Internet network, for transmitting and receiving an animated character message mutually between the terminals, the animated character messaging system comprising:
an editing system for editing a message to be transmitted to the other party, generating an animated character by adding an animation effect to a specific character and generating an animated character message by combining the message to be transmitted with the animated character;
a message storing part for storing an animated character massage to be transmitted and a received animated character massage;
a communication interface allowing the terminals to communicate with each other through the Internet network; and
a messenger system for selecting the animated character message generated by the editing system to then be stored in the message storing part, transmitting the selected animated character message through the communication interface, receiving the animated character message through the communication interface to the be stored in the message storing part and reproducing the message and the animated character from the received animated character message.

2. The animated character messaging system according to claim 1, wherein the messenger system comprises:
a messenger setting part for setting an operating environment of the messenger system;
a message executing part for reproducing the received animated character message;
a message transmission part for transmitting the animated character message stored in the message storing part to the communication interface;
a message reception part for receiving the animated character message from the communication interface to then be stored in the message storing part; and
a control part for controlling the message executing part, message transmission part and message reception part, according to conditions set by the messenger setting part.

3. The animated character messaging system according to claim 2, wherein the message executing part comprises:
a TTS reproducing engine for reproducing letters of the animated character message containing the letters in a TTS mode;
a sound reproducing engine for reproducing sound of the animated character message containing sound; and
a message motion reproducing engine for reproducing motion of the animated character.

4. The animated character messaging system according to claim 3, wherein the messenger setting part has at least one among a function for automatically actuating the messenger system when a terminal is turned on, a function for interrupting transmission of messages from specific persons, a function for setting an operating environment of the TTS reproducing engine and the sound reproducing engine, and a function for adjusting an amplitude of a sound message, and the control part controls the messenger system according to respective conditions set by the messenger setting part.

5. The animated character messaging system according to claim 1, wherein the editing system comprises:
an editing system setting part for setting an operating environment of the editing system;
a character editing part for selecting/editing a character to be transmitted;
a motion editing part for editing a message to be transmitted, generating an animated character by adding an animation effect to the character which the user selects/edits using the character editing part and generating the animated character message by combining the message to be transmitted with the animated character; and
a control part for controlling the character editing part and the motion editing part, according to conditions set by the editing system setting part.

6. The animated character messaging system according to claim 5, wherein the motion editing part comprises:
a TTS letter editing engine for editing a letter message to be transmitted;
a sound editing engine for recording and editing a sound message; and
a message motion editing engine for editing the motion of the character.

7. The animated character messaging system according to claim 6, wherein the editing system setting part has at least one among a function for automatically storing the character message periodically which is being edited, a function for copying/inserting an object, and a drawing tool function related in making characters, and the control part controls the editing system according to respective conditions set by the editing system setting part.

8. The animated character messaging system according to claim 1, wherein the messenger system has at least one among a function for uploading the animated character message to be transmitted to a specified server, a function for transmitting the animated character message to the other party's terminal by trying to directly connect thereto, and a function for transmitting the animated character message to a specified email address.

9. The animated character messaging system according to claim 1, wherein the messenger system has at least one among a function for downloading the received animated character message by connecting to a specified server, a function for receiving the animated character message from the other party's terminal by connecting to the other party's terminal which requests a direct connection, and a function for receiving the animated character message by connecting to a specified email server.
